(19) United States
(12) Patent Application Publication
(10) Pub. No.: US 2020/0410127 A1
(43) Pub. Date: Dec. 31, 2020

(54) SYSTEMS AND METHODS FOR PROVIDING CENTRALIZED AND COMMUNITY-BASED MANAGEMENT OF THREE-DIMENSIONAL PRINTABLE FILES

(71) Applicant: J Two Eight Ltd., Birkirkara (MT)

(72) Inventors: Bruce Basheer, Liscannor (IE); Barry Delaney, Co. Wexford (IE)

(73) Assignee: J Two Eight Limited, Birkirkara (MT)

(21) Appl. No.: 17/010,690

(22) Filed: Sep. 2, 2020

Related U.S. Application Data
(63) Continuation of application No. 15/274,966, filed on Sep. 23, 2016.
(60) Provisional application No. 62/232,942, filed on Sep. 25, 2015.

(51) Int. Cl. G06F 21/62; G06Q 50/18; B33Y 50/00

(52) U.S. Cl. CPC G06F 21/6218; B33Y 50/00; G06Q 50/184

(57) ABSTRACT

Systems and methods are provided for tracking processing of three-dimensional (3D) files. The system receives a request to obtain a three-dimensional file from a three-dimensional file repository. The request is transmitted from a user computer to the three-dimensional file repository. The system validates a request permission associated with the request. The system also validates an intellectual property right associated with the request by transmitting an intellectual property validation request from the three-dimensional repository to an online intellectual property repository. The system processes the request after validating the request permission and the intellectual property right. The system then assigns at least one unique identifier, associated with the processing, to the three-dimensional file.

### CROSS-REFERENCE TO RELATED APPLICATIONS

This application claims benefit to U.S. Non-Provisional application Ser. No. 15/274,966, filed Sep. 23, 2016 which claims the benefit of priority to U.S. Provisional Patent Application No. 62/232,942, filed Sep. 25, 2015, and entitled “Systems and Methods for Providing Centralized and Community-Based Management of Three-Dimensional Printable Files”, the entire contents of which are incorporated herein by reference.

### TECHNICAL FIELD

The present invention generally relates to three-dimensional file printing and more specifically to systems and methods of providing centralized and community-based management of three-dimensional printable files.

### BACKGROUND

Three-dimensional modeling and printing of files is rapidly growing, particularly given the mass and public availability of three-dimensional printers. Although three-dimensional files are being designed and/or printed, typically on an individual or private enterprise level, there is no public community for doing so. Such lack of central management of three-dimensional printable files prevents the traceability of files and the verification of each file's intellectual property rights, and impedes the promotion and distribution of three-dimensional printable files.

Therefore, there is a need for providing systems and methods for centralized and community-based management of three-dimensional printable files. There is also a need (1) for such systems and methods to include open source databases for the management of three-dimensional printable files, (2) to provide capabilities for users to generate and/or upload files, and (3) to offer a level of traceability and user control from developers and/or owners of files.

### SUMMARY

The example embodiments presented herein are directed to systems and methods of providing centralized and community-based management of three-dimensional printable files.

In some exemplary embodiments, 1. A method for managing three-dimensional printable files comprising: receiving, over a network, from a client computing device among a plurality of client computing devices, one or more three-dimensional printable files; storing, in at least one memory associated with a three-dimensional file management system, the received one or more three-dimensional printable files, wherein the at least one memory comprises a plurality of three-dimensional printable files, and wherein the plurality of three-dimensional printable files are associated with a three-dimensional printing community comprising a plurality of users; assigning a unique identifier to each of the one or more three-dimensional printable files; generating metadata corresponding to each of the three-dimensional printable files; and providing access to a graphical user interface, the user interface being used to access, by the plurality of client computing devices, the three-dimensional printing community and the plurality of three-dimensional printable files.

In some exemplary embodiments, the method further comprises: receiving, over the network, from a first client computing device among the plurality of client computing devices, operated by a first user among the plurality of users, a request to access a first three-dimensional printable file from among the plurality of three-dimensional printable files; retrieving, from the at least one memory, based on the first request, the first three-dimensional printable file; and transferring, over the network, to the first client computing device, the retrieved first three-dimensional printable file.

In some exemplary embodiments, the metadata comprises at least one member selected from the group consisting of (a) a tag (e.g., selected and/or input by a user and/or a community of users, e.g., a description), (b) a permission (e.g., a read, write, modify, delete rights, permissions and/or attributes associated a user, a group of users, and/or a community of users), (c) a license (e.g., a copyright license, a distribution license, a modification license, a manufacturing license, a printing license, a derivation license, etc.), (d) a signature (e.g., uniquely identifying an authoring user (or users) and/or a modifying user (or users)), (e) a price (e.g., a price to download the file, a price to print the file per print, etc.), and (f) a portfolio identifier (e.g., associating the file with other stored files of the user or a group of users).

In some exemplary embodiments, the method further comprises: reading, by the three-dimensional file management system, the metadata associated with the first three-dimensional printable file, wherein the transferring is dependent on an authentication process based at least in part upon the metadata of the first three-dimensional printable file and an identity of the first user (e.g., username and password combination) of the first client computing device.

In some exemplary embodiments, the method further comprises receiving, by the three-dimensional file management system, from a second client computing device among plurality of client computing devices, one or more search terms (e.g., a combination of one or more of a tag, a descriptive tag, a description, a permission, a license, a signature, a price, a portfolio identifier, a different user, etc.); identifying, from among the plurality of three-dimensional printable files, a subset of three-dimensional printable files, each of the three-dimensional printable files in the subset having at least a portion of metadata matching the search terms; and causing to display, via the graphical user interface, a listing of the subset of three-dimensional printable files.

In some exemplary embodiments, the retrieved first three-dimensional printable file is transferred, over the network, to a three-dimensional printer, causing the three-dimensional printable file to be printed.

In some exemplary embodiments, the plurality of users are associated with a corresponding profile, wherein each profile includes corresponding user information (e.g., name, associated computing devices, access rights corresponding to three-dimensional printable files, communities, activity (e.g., file access history), access credentials (e.g., username, password), payment credentials (e.g., credit card information)).

In some exemplary embodiments, the method further comprises each of the plurality of users in the three-dimensional printing community is associated with one or more of the other of the plurality of users and/or sub-communities (e.g., by industry (e.g., fashion, medical devices, home improvement)).

In some exemplary embodiments, the first three-dimensional printable file is owned (e.g., created, uploaded) by a second user, wherein the first three-dimensional printable file includes second data corresponding to the second user (e.g., client computing device, MAC address, BIA address), wherein the transfer of the first three-dimensional printable file to the first user causes a copy of the first three-dimensional file stored in the at least one memory associated with the three-dimensional file management system, and wherein the copy of the first three-dimensional printable file transferred to the first user is appended with first data corresponding to the first user (e.g., client computing device, MAC address, BIA address).

In some exemplary embodiments, a system for managing three-dimensional printable files comprises: at least one memory; and a processor communicatively coupled to the at least one memory, the processor being operable to: receive, over a network, from a client computing device among a plurality of client computing devices, one or more three-dimensional printable files; store, in the least one memory, the received one or more three-dimensional printable files, wherein the at least one memory comprises a plurality of three-dimensional printable files, and wherein the plurality of three-dimensional printable files are associated with a three-dimensional printing community comprising a plurality of users; assigning a unique identifier to each of the one or more three-dimensional printable files; generate metadata corresponding to each of the three-dimensional printable files; and provide access to a graphical user interface, the user interface being used to access, by the plurality of client computing devices, the three-dimensional printing community and the plurality of three-dimensional printable files.

In some exemplary embodiments, the processor is further operable to: receive, over the network, from a first client computing device among the plurality of client computing devices, operated by a first user among the plurality of users, a request to access a first three-dimensional printable file from among the plurality of three-dimensional printable files; retrieve, from the at least one memory, based on the first request, the first three-dimensional printable file; and transfer, over the network, to the first client computing device, the retrieved first three-dimensional printable file.

In some exemplary embodiments, the metadata comprises at least one member selected from the group consisting of (a) a tag (e.g., selected and/or input by a user and/or a community of users, e.g., a description), (b) a permission (e.g., a read, write, modify, delete rights, permissions and/or attributes associated a user, a group of users, and/or a community of users), (c) a license (e.g., a copyright license, a distribution license, a modification license, a manufacturing license, a printing license, a derivation license, etc.), (d) a signature (e.g., uniquely identifying an authoring user (or users) and/or a modifying user (or users)), (e) a price (e.g., a price to download the file, a price to print the file per print, etc.), and (f) a portfolio identifier (e.g., associating the file with other stored files of the user or a group of users).

In some exemplary embodiments, the processor is further operable to: read the metadata associated with the first three-dimensional printable file, wherein the transferring is dependent on an authentication process based at least in part upon the metadata of the first three-dimensional printable file and an identity of the first user (e.g., username and password combination) of the first client computing device.

In some exemplary embodiments, the processor is further operable to: receive, from a second client computing device among plurality of client computing devices, one or more search terms (e.g., a combination of one or more of a tag, a descriptive tag, a description, a permission, a license, a signature, a price, a portfolio identifier, a different user, etc.); identify, from among the plurality of three-dimensional printable files, a subset of three-dimensional printable files, each of the three-dimensional printable files in the subset having at least a portion of metadata matching the search terms; and cause to display, via the graphical user interface, a listing of the subset of three-dimensional printable files.

In some exemplary embodiments, the retrieved first three-dimensional printable file is transferred, over the network, to a three-dimensional printer, causing the three-dimensional printable file to be printed.

In some exemplary embodiments, the plurality of users are associated with a corresponding profile, wherein each profile includes corresponding user information (e.g., name, associated computing devices, access rights corresponding to three-dimensional printable files, communities, activity (e.g., file access history), access credentials (e.g., username, password), payment credentials (e.g., credit card information)).

In some exemplary embodiments, each of the plurality of users in the three-dimensional printing community is associated with one or more of the other of the plurality of users and/or sub-communities (e.g., by industry (e.g., fashion, medical devices, home improvement)).

In some exemplary embodiments, the first three-dimensional printable file is owned (e.g., created, uploaded) by a second user, wherein the first three-dimensional printable file includes second data corresponding to the second user (e.g., client computing device, MAC address, BIA address), wherein the transfer of the first three-dimensional printable file to the first user causes a copy of the first three-dimensional file stored in the at least one memory associated with the three-dimensional file management system, and wherein the copy of the first three-dimensional printable file transferred to the first user is appended with first data corresponding to the first user (e.g., client computing device, MAC address, BIA address).

In some exemplary embodiments, in a method of tracking processing of three-dimensional (3D) files, a three-dimensional file repository receives a request to obtain a three-dimensional file from a three-dimensional file repository. The request is transmitted from a user computer to the three-dimensional file repository, where the three-dimensional file is associated with a three-dimensional printing community comprising a plurality of users. The three-dimensional file repository validates a request permission associated with the request. The three-dimensional file repository also validates an intellectual property right associated with the request by transmitting an intellectual property validation request from the three-dimensional repository to an online intellectual property repository. The three-dimensional file repository processes the request after validating the request permission and the intellectual property right, and then assigns at least one unique identifier, associated with the processing, to the three-dimensional file.

In some exemplary embodiments, when the three-dimensional file repository receives the request to obtain the three-dimensional file from the three-dimensional file repository, the three-dimensional file repository receives a download request from the user computer to download the three-dimensional file from the three-dimensional file repository. When the three-dimensional file repository processes the request after validating the request permission and the intellectual property right, the three-dimensional file repository obtains a unique printer identifier associated with a three-dimensional printer associated with the download request. The three-dimensional file repository transmits the three-dimensional file from the three-dimensional file repository directly to the three-dimensional printer. When the three-dimensional file repository assigns at least one unique identifier, associated with the processing, to the three-dimensional file, the three-dimensional file repository assigns the unique printer identifier as at least one of the unique identifiers associated with the processing of the three-dimensional file.

In some exemplary embodiments, when the three-dimensional file repository receives the request to obtain the three-dimensional file from the three-dimensional file repository, the three-dimensional file repository receives an upload request to upload the three-dimensional file to the three-dimensional file repository. When the three-dimensional file repository processes the request after validating the request permission and the intellectual property right, the three-dimensional file repository obtains at least one unique device identifier from the device transmitting the upload request. When the three-dimensional file repository assigns at least one unique identifier, associated with the processing, to the three-dimensional file, the three-dimensional file repository assigns each of the unique device identifiers as one of the unique identifiers associated with the processing of the three-dimensional file.

In some exemplary embodiments, when the three-dimensional file repository validates the intellectual property right associated with the request, the three-dimensional file repository connects to the online intellectual property repository associated with the intellectual property right. The three-dimensional file repository validates the intellectual property right through the online intellectual property repository, where the intellectual property right is at least one of a copyright, trademark and patent.

### BRIEF DESCRIPTION OF THE DRAWINGS

Various aspects of at least one embodiment are discussed below with reference to the accompanying figures, which are not necessarily drawn to scale, emphasis instead being placed upon illustrating the principles disclosed herein. The figures are included to provide an illustration and a further understanding of the various aspects and embodiments, and are incorporated in and constitute a part of this specification, but are not intended as a definition of the limits of any particular embodiment. The figures, together with the remainder of the specification, serve only to explain principles and operations of the described and claimed aspects and embodiments, but are not to be construed as limiting embodiments. In the figures, each identical or nearly identical component that is illustrated in various figures is represented by a like numeral. For purposes of clarity, not every component may be labeled in every figure.

The foregoing and other objects, aspects, features, and advantages of the present disclosure will become more apparent and better understood by referring to the following description taken in conjunction with the accompanying drawings, in which:

FIG. 1 is a block diagram of an example community for sharing of three dimensional printable files, according to an illustrative embodiment of the present disclosure.

FIG. 2 is a chart of an example method for managing three dimensional printable files, according to an illustrative embodiment of the present disclosure.

FIG. 3 is a block diagram of an example network environment, according to an illustrative embodiment if the present disclosure.

FIG. 4 is a block diagram of an example computing device and an example mobile computing device, for use in illustrative embodiments of the present disclosure.

FIG. 5 is a block diagram of an embodiment of a system for tracking processing of a three-dimensional file, according to an illustrative embodiment of the present disclosure.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE ILLUSTRATIVE EMBODIMENTS

The present disclosure presents centralized and community-based management of three-dimensional printable files.

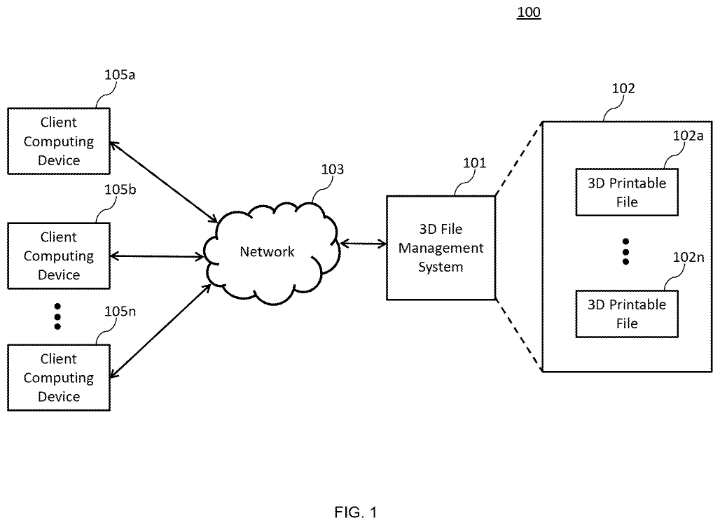

FIG. 1 illustrates a system 100 for centralized and community-based management of three-dimensional printable files, according to an exemplary embodiment. The system 100 includes a three-dimensional file management system 101 connected, via a network 103, to a plurality of client computing devices 105a, 105b, . . . , 105n. The three-dimensional file management system 101 includes at least one processor and at least one memory or storage device. In some exemplary embodiments, the file management system 101 includes one or more servers such as database servers, file servers, mail servers, print servers, web servers, gaming servers, application servers, and the like.

The three-dimensional file management system 101 is used to manage a community of users (e.g., a social network, vertical market) that create, upload, download, and perform such other actions with respect to files such as three-dimensional printable files. That is, in some exemplary embodiments, users belonging to a three-dimensional printable file community use client computing devices (e.g., 105a) to access interfaces (e.g., graphical user interfaces) provided by the three-dimensional file management system 101, for example, via software stored on the client computing devices or via a web-based application. The software and/or web-based application may be provided and/or managed by the three-dimensional file management system.

In some exemplary embodiments, the client computing devices may be laptop computers, desktop computers, mobile devices, wearable devices, or the like. The network 103 may be a virtual private network (VPN), local area network (LAN), personal area network (PAN), wide area network (WAN), the Internet, and the like. It should be understood that although the network 103 is illustrated as a single element in FIG. 1, the network 103 may include any number and combination of networks.

More specifically, as shown in FIG. 1, the three-dimensional file management system 101 stores and/or manages a set of three-dimensional printable files 102 (e.g., 102a, . . . , 102n). That is, three-dimensional printable files may be shared (e.g., by users) via the three-dimensional file management system, for example, by being uploaded to the system by users via the client computing devices. The shared files may in turn be downloaded by users of the community. Each user of the community is associated with a corresponding profile, which is managed (e.g., stored, tracked) by the file management system. A profile may include information associated with the corresponding user, user's activity, user's computing device(s), and/or user's files. That is, if a user uploads a file to the file management system 101, the file is linked to the user's profile. In this way, users can develop portfolios of files, which they can promote, advertise, and/or share through or in association with their respective profiles. In some exemplary embodiments, files can be shared for a cost or at no cost. That is, the file management system allows for the development and monetization of a scalable database of three-dimensional printable files (e.g., bespoke, on-demand market of three-dimensional printable files created and shared between users).

Although not illustrated in FIG. 1, it should be understood that the three-dimensional file management system 101 and/or the client computing devices 105 may be connected to three-dimensional printers, for example, via the network 103. In some exemplary embodiments, three-dimensional printable files are transmitted to the three-dimensional printers connected to the network 103. Such transfer to the printers may be done, for example, in response to a request form a client computing device.

The three-dimensional file management system 101, by storing files and the access thereto, provides tracking and tracing of, for example, usage of three-dimensional printable files within an online membership community. In some exemplary embodiments, the system 101 stores, in association with each file, intellectual property rights, for example whether there is a patent, trademark and/or copyright associated with the file, and/or whether the user attempting to download the file has been granted the rights to do so. In turn, when a user attempts to download, print and/or modify a file, the system 101 verifies whether the file can be printed by that user (e.g., whether the user is the owner of the copyright of a copyrighted file). In some exemplary embodiments, files are automatically registered by the system 101. In some exemplary embodiments, uploading users register each file when uploading the file. Registering a file may include inputting and/or assigning metadata for a file. In some exemplary embodiments, registering a file includes generating a unique identifier corresponding to a file. The unique identifier is used to track each file, perform searches of that file, and store and/manage the file in databases and/or servers associated with the system 101.

In some exemplary embodiments, user may join and/or belong to one or more communities or sub-communities. Communities or sub-communities may be based on types of industries, such as fashion, medical devices and/or home improvement. This way, files may be associated with communities and/or sub-communities, and thus accessible by their members. In some exemplary embodiments, when a file is uploaded and/or added to a community or sub-community, the file is registered with a unique identifier as well as the community or community identifier to which it has been uploaded.

In some exemplary embodiments, owners of three-dimensional printable files may specify the level of usage of the file, for example, whether other and/or which users or types of users can download, upload, modify, etc. copies of the file (e.g., for printing). In some exemplary embodiments, owners of the file can specify a price for the file, how many times it can be downloaded and/or printed, and similar restrictions, all of which can be stored and tracked by the system 101. In some exemplary embodiments, when a user downloads a file, another unique identifier is added to the address of the downloaded file. The other unique identifier added to the downloaded file may include information associated with the downloading user, usage data, computing device data, or the like. In some exemplary embodiments, certain hardware coded network identifiers (e.g., MAC or BIA address of the uploader of the file) is included with files, allowing those files to be tracked and maintained. In this way, users may not upload a trademarked or copyrighted file, in which they do not own the intellectual property rights.

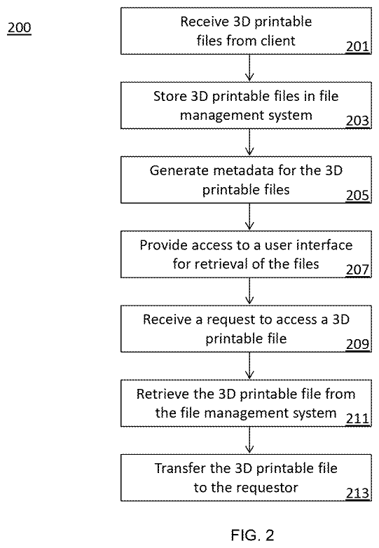

FIG. 2 is a chart of an example method for managing three dimensional (3D) printable files, according to an illustrative embodiment of the present disclosure. In certain embodiments, the method provides for a host computing device (e.g., a server) having access to one or more storage volumes (e.g., physical storage volumes such as hard drives, solid state disks, and the like, and/or cloud storage) connected to a network (e.g., the internet). In some embodiments, the host computing device is the three-dimensional printable file management system 101. The host computing device may provide a collection of three-dimensional printable files (e.g., STL files or other three-dimensional model representations and/or additive manufacturing model representations) and a collection of user profiles (e.g., in a database). In certain embodiments, the host computing device receives a 3D printable file from a client computing device (e.g., any of client computing devices 102) [201]. The host computing device stores the 3D printable file in a memory associated with a 3D printable file management system (such as 3D printable file management system 101) [203]. In several embodiments, the memory associated with the 3D printable file management system comprises a plurality of three-dimensional printable files. In some embodiments, the plurality of three-dimensional files has been uploaded by a plurality of users associated with a plurality of client computing devices (such as client computing devices 102).

Accordingly, the 3D printable file management system generates metadata for the received file (e.g., automatically based on an identity of the user or based on the contents of the file, including metadata which may be present in the received file; e.g., based on a selection by the user and/or an administrator of the 3D printable file management system) [205]. Such metadata may include a tag (e.g., a descriptive tag, a categorical tag, etc.; e.g., selected and/or input by a user and/or a community of users; e.g., a description), a permission (e.g., a read, write, modify, delete rights, permissions and/or attributes associated a user, a group of users, and/or a community of users), a signature (e.g., a unique data identifying the author or modifier of the file, such as a MAC address, BIA address, IP address, etc.), a license (e.g., a copyright license, a distribution license, a modification license, a manufacturing license, a printing license, a derivation license, etc.), a price (e.g., a price to download the file, a price to print the file per print, etc.), and (f) a portfolio identifier (e.g., associated with a profile in a 3D printing community; e.g., associating the file with other stored files of the user or a group of users).

In some exemplary embodiments, the 3D printable file management system is associated with a community of users who access and/or contribute files in a 3D printing community. In certain embodiments, the community is an open source community. In several embodiments, the 3D printable file management system comprises a database, the database comprising the 3D printable files (or an association with a storage volume comprising the 3D printable files), a unique identifier associated with each of the 3D printable files, and any metadata associated with the 3D printable files (or an association with a storage volume comprising the metadata). In some embodiments, the 3D printing community comprises a platform for accessing and sharing 3D printable files (e.g., uploading and downloading). In certain embodiments, the platform further comprises a number of features to foster a 3D printable file sharing community, for example:
a user profile page, or other profile page (e.g., a group page, a company page, a sub-community page (e.g., a fashion accessory community, a medical device community, a home improvement community, etc.)) where users and groups can display their contributed 3D printable files for the community, as well as be included in search results.
an online portfolio, where users can develop a portfolio of their work, for example, associated with their user or group profile.
blogs and discussion pages, where users can engage in community-based activities.
monetization of 3D printable files and design 3D printable files
the ability to sell and/or restrict access to 3D printable files, in order to preserve and or monetize intellectual property rights in the 3D printable files; and/or:
bespoke, on-demand 3D printing files created and shared between users.

In some exemplary embodiments, the platform provides access to a user interface (e.g., through a web browser and/or a mobile application) to access, search, retrieve, share, upload, sell, and design 3D printable files [207]. In certain embodiments, the authoring user and/or members of the community can tag files with various information (e.g., a sub-community, a description, a compatibility, or any other useful tag).

Use of the 3D file management system will now be discussed with reference to the Figures. The 3D printable file management system receives a request from a user of a client computing device to access a 3D printable file (e.g., to search, retrieve, share, purchase, etc.) [209]. The 3D printable file management system may verify that the requesting user has the right access the file (e.g., the intellectual property right, license, etc.; e.g., has purchased the right to access the file; e.g., the file is intended for sharing; etc.). Upon determining that the user is authorized to access the file, the 3D printable file management system retrieves the 3D printable file from memory (e.g., a storage location) [211].

Once the user is authorized and the file retrieved, the 3D printable file management system transfers the 3D printable file to the requestor [213]. In certain embodiments, the 3D printable file may initiate and/or present a download of the file to the client-computing device. In other embodiments, the 3D printable file management system may e-mail the file to an e-mail account associated with the user of the client-computing device. In some embodiments, the 3D printable file system may transfer the file to a 3D printing device.

In some exemplary embodiments, the platform may provide a user interface to a search option. In several embodiments, a user enters one or more search terms, which may include a description or any other metadata or information associated with the plurality of files in the three-dimensional file management system. The platform may execute the search and present a list of one or more files that match the search terms. The platform may enable the user to select from a list of the files to request access to the file and/or purchase access to the file.

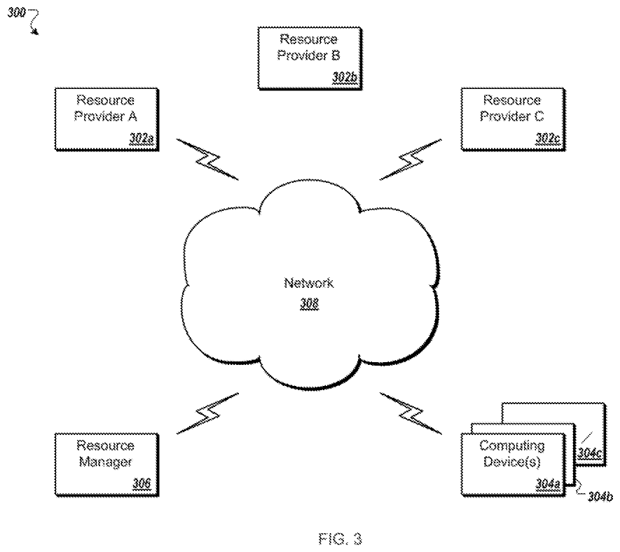

FIG. 3 shows an illustrative network environment 300 for use in managing three-dimensional printable files, as described herein. In brief overview, referring now to FIG. 3, a block diagram of an exemplary cloud-computing environment 300 is shown and described. The cloud-computing environment 300 may include one or more resource providers 302a, 302b, 302c (collectively, 302). Each resource provider 302 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 302 may be connected to any other resource provider 302 in the cloud-computing environment 300. In some implementations, the resource providers 302 may be connected over a computer network 308. Each resource provider 302 may be connected to one or more computing device 304a, 304b, 304c (collectively, 304), over the computer network 308.

The cloud-computing environment 300 may also include a resource manager 306. The resource manager 306 may be connected to the resource providers 302 and the computing devices 304 over the computer network 308. In some implementations, the resource manager 306 may facilitate the provision of computing resources by one or more resource providers 302 to one or more computing devices 304. The resource manager 306 may receive a request for a computing resource from a particular computing device 304. The resource manager 306 may identify one or more resource providers 302 capable of providing the computing resource requested by the computing device 304. The resource manager 306 may select a resource provider 302 to provide the computing resource. The resource manager 306 may facilitate a connection between the resource provider 302 and a particular computing device 304. In some implementations, the resource manager 306 may establish a connection between a particular resource provider 302 and a particular computing device 304. In some implementations, the resource manager 306 may redirect a particular computing device 304 to a particular resource provider 302 with the requested computing resource.

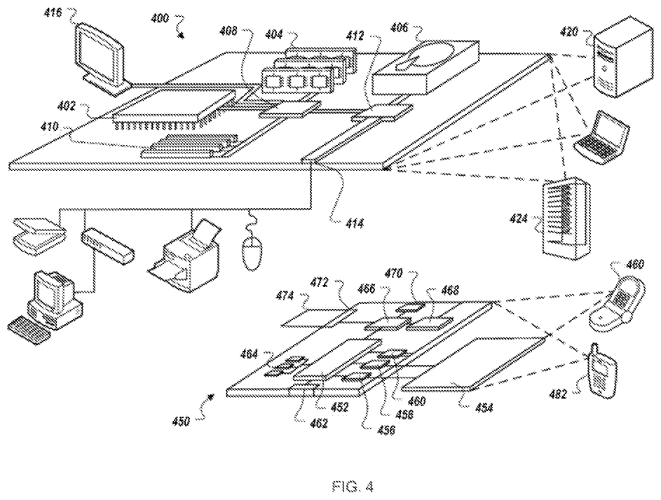

FIG. 4 shows an example of a computing device 400 and a mobile computing device 450 that can be used in the methods and systems described in this disclosure. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine-readable mediums (for example, the memory 404, the storage device 406, or memory on the processor 402).

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device (not shown), such as a mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 452), perform one or more methods, such as those described above. The instructions can also be stored by one or more storage devices, such as one or more computer, or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 468 using a radio-frequency. In addition, short-range communication may occur, such as using a Bluetooth®, Wi-Fi™, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in FIG. 4. For example, it may be implemented as a cellular telephone 480. It may also be implemented as part of a smart-phone 482, personal digital assistant, or other similar mobile device.

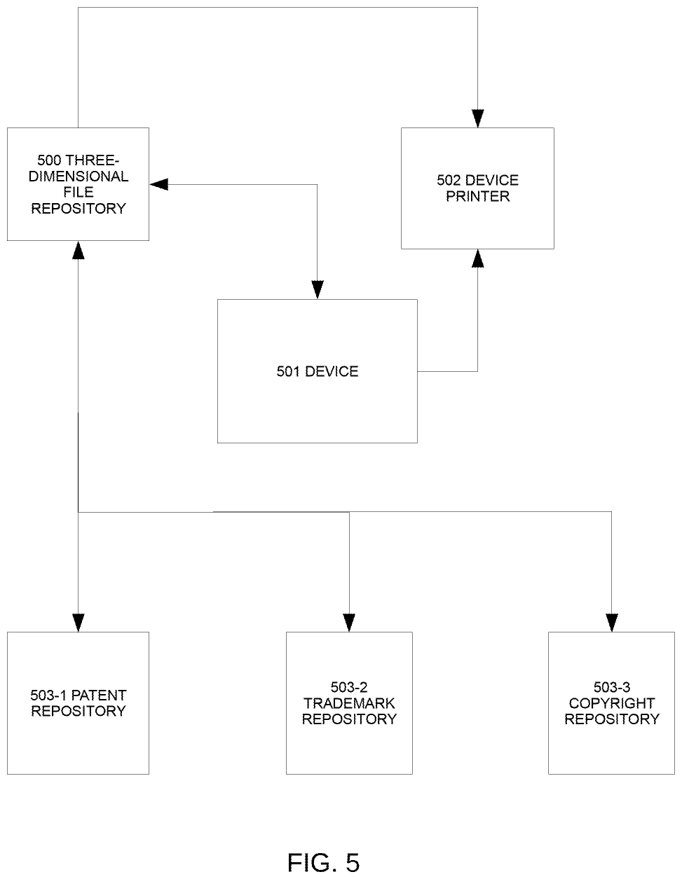

FIG. 5 is an exemplary embodiment of a system for tracking processing of a three-dimensional file that can be used in the methods and systems described in this disclosure. In an exemplary embodiment, the three-dimensional file repository 500 receives a request from a device 501 to obtain a three-dimensional file from a three-dimensional file repository 500. The request may be transmitted, for example, from a user computer (i.e., device 501) to the three-dimensional file repository 500. The three-dimensional file is associated with a three-dimensional printing community comprising a plurality of users. The three-dimensional file repository 500 validates a request permission associated with the request, and validates an intellectual property right associated with the request. In an example embodiment, the three-dimensional file repository 500 validates the intellectual property right by transmitting an intellectual property validation request from the three-dimensional repository 500, to an online intellectual property repository 503-N. The three-dimensional file repository 500 connects to the online intellectual property repository 503-N associated with the intellectual property right. The three-dimensional file repository 500 then validates the intellectual property right through the online intellectual property repository 503-N. The intellectual property right may be at least one of a copyright, trademark and patent. In an example embodiment, the online intellectual property repository 503-N receives the intellectual property validation request, performs the validation, and transmits an intellectual property response back to the three-dimensional repository 500. After the three-dimensional file repository 500 validates the request permission and the intellectual property right, the three-dimensional file repository 500 processes the request. The three-dimensional file repository 500 then assigns at least one unique identifier, associated with the processing, to the three-dimensional file.

In an exemplary embodiment, when the three-dimensional file repository 500 validates the intellectual property right through the online intellectual property repository 503-N, the three-dimensional file repository 500 determines whether there exist any intellectual property protection for the three-dimensional file. If the three-dimensional file repository 500 determines that none exists, and the user is attempting to upload the three-dimensional file to the three-dimensional repository 500, the three-dimensional file repository 500 notifies the user, and prompts the user to obtain the intellectual property protection for the three-dimensional file. The three-dimensional file repository 500 may then re-connect to the online intellectual property repository 503-N to assist the user with obtaining the intellectual property protection. For example, the three-dimensional file repository 500 may connect to the user's country Copyright Office (or, for example, the country from which the user is uploading the three-dimensional file) to assist the user with beginning the process of obtaining copyright protection for the three-dimensional file.

In an exemplary embodiment, when the three-dimensional file repository 500 receives the request, from the user, to obtain the three-dimensional file from the three-dimensional file repository 500, the three-dimensional file repository 500 receives a download request to download the three-dimensional file from the three-dimensional file repository 500. For example, a user may send the download request from a device 501 to the three-dimensional repository 500 to download a three-dimensional file. After validating the request permission and the intellectual property right, the three-dimensional file repository 500 obtains a unique printer identifier associated with a three-dimensional printer 502 associated with the download request. For example, when the user tries to download the three-dimensional file from the three-dimensional repository 500, the three-dimensional file repository 500 invokes a printer interface request, requesting that the user supply the name of the three-dimensional printer 502 from which the three-dimensional file is to be printed. Once the three-dimensional printer 502 is identified, a unique printer identifier associated with the three-dimensional printer 502 is provided. The unique printer identifier may be, but is not limited to, a MAC address, a unique physical port identifier, etc. The three-dimensional file repository 500 then transmits the three-dimensional file from the three-dimensional file repository 500 directly to the three-dimensional printer 502. In other words, the three-dimensional file repository 500 does not download the three-dimensional file to the device 501, but rather, transmits the three-dimensional file directly to the three-dimensional printer 502 to be printed. The three-dimensional file repository 500 assigns the unique printer identifier as at least one unique identifier associated with the processing of the three-dimensional file. Thus, the three-dimensional file repository 500 is able to track which three-dimensional printers have printed a specific three-dimensional file.

If the user is attempting to download a three-dimensional file, when the three-dimensional file repository 500 validates the intellectual property rights, the three-dimensional file repository 500 validates whether the user has permission to download the three-dimensional file. If the user does not have permission, the three-dimensional file repository 500 notifies the user, and the three-dimensional file is not downloaded to the user's computer (i.e., device 501), nor is it transmitted directly to a three-dimensional printer 502 for printing. If the user has permission to download the three-dimensional file, the three-dimensional file repository 500 determines how many copies of the three-dimensional file the user is permitted to print. If the user has permission to print, for example, two copies of the three-dimensional file, the three-dimensional file repository 500 provides the user with a printer interface. The user may then specify which printer(s) 502 from which to print the two copies of the three-dimensional file. The three-dimensional file repository 500 then transmits the two copies of the three-dimensional files directly to the printer(s) 502 specified by the user. The three-dimensional file repository 500 will transmit for printing only the number of copies the user is permitted to print. Thus, if the user is permitted to print two copies, and provides the information for two different printers 502, the three-dimensional file repository 500 will transmit only one copy of the three-dimensional file directly to each of the two printers 502 specified by the user.

In an example embodiment, the request to obtain the three-dimensional file from the three-dimensional file repository 500 is an upload request to upload the three-dimensional file to the three-dimensional file repository 500. For example, the user may be uploading a three-dimensional file to the three-dimensional file repository 500. In this example embodiment, after validating the request permission and the intellectual property right, the three-dimensional file repository 500 obtains one or more unique device identifiers from the device 501 transmitting the upload request. For example, the unique device identifier may be, but is not limited to, a MAC address associated with the device 501, a user identifier, the three-dimensional printing community the user is associated with, a software application used to create/modify the three-dimensional file, the IP address of the device 501, etc. The three-dimensional file repository 500 assigns each of the one or more unique device identifiers as the unique identifiers associated with the processing of the three-dimensional file.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples or embodiments are not intended to be excluded from a similar role in any other examples or embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Those skilled in the art will appreciate that the conception, upon which this disclosure is based, may readily be utilized as a basis for designing other products without departing from the spirit and scope of the invention as defined by the appended claims. Therefore, the claims are not to be limited to the specific examples depicted herein. For example, the features of one example disclosed above can be used with the features of another example. Furthermore, various modifications and rearrangements of the parts may be made without departing from the spirit and scope of the underlying inventive concept. For example, the geometric configurations disclosed herein may be altered depending upon the application, as may the material selection for the components. Thus, the details of these components as set forth in the above-described examples, should not limit the scope of the claims.

Further, the purpose of the Abstract is to enable the U.S. Patent and Trademark Office, and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the claims of the application nor is intended to be limiting on the claims in any way.

What is claimed is:

1. A three-dimensional file management system for tracking processing of three-dimensional (3D) files, the system comprising:
at least one memory comprising a plurality of three-dimensional printable files, wherein the three-dimensional printable files are associated with a three-dimensional printing community comprising a plurality of client computing devices and associated users;
one or more processors communicatively coupled to the at least one memory and configured to execute instructions stored in the at least one memory which cause the processor to:
assign a unique identifier to each of the one or more three-dimensional printable files;
generate metadata corresponding to each of the three-dimensional printable files;
provide access to a graphical user interface, the user interface used to allow the plurality of client computing devices to access the three-dimensional printing community and the plurality of three-dimensional printable files;
receive, over a network, from a first client computing device operated by a first user, one or more search terms;
identify from among the plurality of stored three-dimensional printable files, a subset of three-dimensional printable files, wherein each of the three-dimensional printable files in the subset has at least a portion of metadata matching the one or more search terms provided by the first client computing device;
retrieve from the at least one memory, the identified subset of three-dimensional printable files having the at least portion of metadata matching the one or more search terms provided by the first client computing device;
display, via a graphical user interface, a listing of the identified subset of three-dimensional printable files having the at least portion of metadata matching the one or more search terms provided by the first client computing device; and
transfer, over the network, to a three-dimensional printer causing the identified subset of three-dimensional printable files to be printed.

2. The three-dimensional file system of claim 1, wherein the one or more search terms comprise a combination of two or more of a tag, a descriptive tag, a description, a permission, a license, a signature, a price, a portfolio identifier, a different user.

3. The three-dimensional file system of claim 1, wherein each of the plurality of users are associated with a corresponding user profile, wherein each user profile includes corresponding user information.

4. The three-dimensional file system of claim 3, wherein the user information comprises at least a user's name, a computing device associated with the user, one or more access rights corresponding to the three-dimensional printable files, and at least one or more of a community, a file access history, access a credential including at least a username and a user password, and a payment credential.

5. The three-dimensional file system of claim 1, wherein each of the plurality of users in the three-dimensional printing community is associated with one or more other users from among of the plurality of users

6. The three-dimensional file system of claim 1, wherein each of the plurality of users in the three-dimensional printing community is associated with one or more sub-communities, wherein each sub-community is defined by a particular industry.

7. The three-dimensional file system of claim 1, wherein the metadata comprises at least one member selected from the group consisting of a tag, a permission, a license, a signature, a price, and a portfolio identifier.

8. The three-dimensional file system of claim 7, wherein the tag is selected and/or input by one of a user or a community of users.

9. The three-dimensional file system of claim 7, wherein the permission is one of a read permission, a write permission, a modify permission, a delete rights permission.

10. The three-dimensional file system of claim 9, wherein the permission is associated with a single user.

11. The three-dimensional file system of claim 9, wherein the permission is associated with one of a group of users and a community of users.

12. The three-dimensional file system of claim 9, wherein the license is one of a copyright license, a modification license, a manufacturing license, a printing license, a derivation license.

13. The three-dimensional file system of claim 1, wherein the transferring is dependent on an authentication process based at least in part upon the metadata of the first three-dimensional printable file and an identity of the first user of the first client computing device.

14. A system for tracking processing of three-dimensional (3D) files, the system comprising:
at least one memory;
one or more processors communicatively coupled to the at least one memory and configured to execute instructions stored in the at least one memory which cause the processor to:
receive a request concerning a three-dimensional file stored in a three-dimensional file repository, the request selected from the group consisting of a download request and an upload request,
the three-dimensional file repository comprising a database configured and arranged to store three-dimensional files, the database comprising one or more servers comprising at least one of the one or more processors, memory, and storage,
the request transmitted from a user computer to the three-dimensional file repository, wherein the requested three-dimensional file is associated with a three-dimensional printing community comprising a plurality of users;
validate, with the three-dimensional file repository, a request permission of the user computer associated with the request;
validate an intellectual property right associated with the request by transmitting an intellectual property validation request from the three-dimensional repository to an online intellectual property repository and,
if no intellectual property right is associated with the request, generating a notification to the user indicating that no intellectual property right is associated with the request and, if the request is an upload request, prompting the user to obtain the intellectual property protection for the three-dimensional file, re-connecting the three-dimensional file repository to the online intellectual property repository to assist the user to obtain the intellectual property protection;
process the request after validating the request permission and the intellectual property right; and
where the request comprises an upload request, obtain, by the three-dimensional file repository, at least one unique device identifier from the user computer transmitting the request in connection with the upload request;
where the request comprises an upload request, assign at least one unique repository identifier with the three-dimensional file repository, associated with the processing, to the three-dimensional file, the at least one unique repository identifier corresponding to the at least one unique device identifier from the user computer transmitting the request in connection with the upload request;
where the request comprises a download request, obtain by the three-dimensional file repository, a unique printer identifier associated with a three-dimensional printer associated with the download request;
where the request comprises a download request, assign at least one unique repository identifier with the three-dimensional file repository, associated with the processing, to the three-dimensional file, the at least one unique repository identifier corresponding to a unique printer identifier associated with a three-dimensional printer associated with the download request.

15. The system of claim 14 wherein the processor is further configured to: transmit the three-dimensional file from the three-dimensional file repository directly to the three-dimensional printer.

16. The system of claim 1 wherein the unique identifier is selected from the group consisting of: a MAC address associated with the device, a user identifier, the three-dimensional printing community the user is associated with, a software application used to create/modify the three-dimensional file, an IP address of the device.

17. The system of claim 14 wherein the processor is further configured to connect to the online intellectual property repository associated with the intellectual property right,
the online intellectual property repository comprising a database configured and arranged to store intellectual property rights and permissions of the plurality of users to access the intellectual property rights,
the database comprising one or more servers comprising one or more processors, memory, and storage; and
validate the intellectual property right through the online intellectual property repository with the three-dimensional file repository, wherein the intellectual property right is at least one of a copyright, trademark and patent, and
wherein the intellectual property repository comprises one or more of a patent repository, a trademark repository, and a copyright repository.

18. The system of claim 14 wherein the processor is further configured to, upon receiving a request to upload a three-dimensional file to the three-dimensional file repository and during validation of the intellectual property right associated with the request, prevent a user from uploading a three-dimensional file if the user does not have permission.

19. The system of claim 14 wherein the plurality of users are each associated with a corresponding profile, wherein each profile includes corresponding user information, communities, activity, access credentials, payment credentials, wherein the activity associated with said corresponding profile includes a file access history, and wherein the access credentials corresponding to the three-dimensional printable files include a username and password.

20. The system of claim 14 wherein the corresponding user information includes, a name, one or more associated computing devices, access rights corresponding to the three-dimensional printable files.
